(19) United States
(12) Patent Application Publication
(10) Pub. No.: US 2026/0351861 A1
(43) Pub. Date: Nov. 5, 2026

(54) ANTENNA STRUCTURE

(71) Applicant: BAE SYSTEMS plc, London (GB)

(72) Inventor: Mark Christopher NGUYEN, Essex (GB)

(21) Appl. No.: 19/197,508

(22) Filed: May 2, 2025

(51) Int. Cl. H01Q 21/06; H01Q 9/18

(52) U.S. Cl. CPC H01Q 21/065; H01Q 9/18

(57) ABSTRACT

The present disclosure relates to an antenna structure comprising a ground plane, a plurality of antenna unit cells spaced from the ground plane, and a superstructure spaced from the antenna unit cells, wherein the superstructure comprises a plurality of superstructure unit cells, and wherein each superstructure unit cell comprises a plurality of conductive frustums, wherein each frustum is arranged such that a base thereof is oriented parallel to the ground plane.

### FIELD

The present disclosure relates to an antenna structure, and in particular to an antenna structure having a superstructure configured for improved wide angle impedance matching (“WAIM”).

### BACKGROUND

Antenna arrays are routinely used for transmission and receipt of electromagnetic signals, for example radio signals. A commonly used type of antenna array is a patch antenna. In a patch antenna, a plurality of antenna patches are arranged above an antenna ground plane. The ground plane is connected to electrical ground, and the plurality of patches are coupled to a drive circuit (e.g. PCB drive circuit) for transmission or receipt of electromagnetic signals. Typically, the antenna patches are driven as dipole pairs.

One particular type of patch antenna is a planar patch antenna. In a planar patch antenna, the patches are oriented parallel to the ground plane.

Another type of patch antenna is a perpendicular patch antenna. In a perpendicular patch antenna, the patches are oriented perpendicular to the ground plane.

Patch arrays have high gain in the direction of the patches (i.e. away from the ground plane), and have low gain in the opposite direction. Accordingly, they are highly directional. Another advantage of patch arrays is that they are comparatively inexpensive to manufacture, and can be lightweight, because the ground sheet and the patches can be thin.

In order to improve antenna performance, various superstructures can be used. As the name suggests, an antenna superstructure sits above the antenna elements, such that the patches of the antenna are located between the superstructure and the ground plane. Antenna superstructures interact with electromagnetic signals which are incident upon the antenna structure, or with electromagnetic signals transmitted from the antenna elements, in order to improve properties of the antenna structure as a whole.

One type of superstructure used are wide-angle impedance matching (“WAIM”) structures. WAIM structures are superstructures which can help to improve antenna scanning performance. Antenna scanning is the process of changing the direction of an antenna's main lobe, thereby enabling the antenna to scan for signals coming from different directions relative to the antenna surface (e.g. directions other than normal to the antenna surface), or equivalently enabling the antenna to control the direction in which a signal is transmitted. Improved scanning performance in the present document refers to increasing the angular range over which an antenna is able to scan, or improving antenna efficiency at non-normal incidence.

Various superstructures are known. For example, “Methodology for Improving Scanning Performance Loading an Array Element with a 3D All-Metal WAIM” by Diego Bermudez-Martin et al. discloses a 3D wide-angle impedance matching (“WAIM”) structure which is said to improve scanning performance.

Antenna bandwidth is defined in this document as the ratio of the maximum working bandwidth of an antenna to the minimum working bandwidth of an antenna. In some industries, there is a general desire to improve antenna bandwidth, such that a single antenna can be used for an increased number of frequency bands.

A problem with many WAIM structures is that they do not improve antenna bandwidth, and in some cases may actually reduce antenna bandwidth relative to the same antenna structure operating without the superstructure. Demand exists, therefore, for a superstructure which is able to improve both scanning performance and bandwidth of the underlying antenna.

### SUMMARY

According to a first aspect of the present disclosure, there is provided an antenna structure comprising: a ground plane; a plurality of antenna unit cells spaced from the ground plane; and a superstructure spaced from the antenna unit cells, wherein the superstructure comprises a plurality of superstructure unit cells, and wherein each superstructure unit cell comprises at least one conductive frustum, wherein the at least one frustum is arranged such that a base thereof is oriented parallel to the ground plane.

It has been found that a superstructure having such conductive frustums improves scanning performance of the antenna structure and thus operates as an effective WAIM, while additionally improving bandwidth of the underlying antenna. It has been found that bandwidths of 8:1 can be achieved with such a superstructure. The superstructure used in the present disclosure may therefore be referred to herein as a WAIM superstructure.

Without wishing to be bound by theory, it is the use of cones which enables the WAIM structure to operate over a large bandwidth (which has been demonstrated at 8:1 for a planar patch antenna array). In particular, the variation in the cone diameter with increased distance from the ground plane along the z-axis enables operation over a wide bandwidth.

Where other systems may rely on the use of resistive or capacitive elements to improve bandwidth when a WAIM structure is used, the present disclosure does not require the use of such resistive or capacitive elements. Accordingly, antenna efficiency is improved, which may be particularly advantageous for use as a high-power transmitting antenna.

As the skilled reader knows, a frustum is a tapered 3-dimensional object which is formed by cutting the ‘top’ off a cone or a pyramid, such that the base and the top of the resulting shape are parallel planar surfaces. A frustum may thus alternatively be referred to as a truncated cone, tapered from a first end thereof to a second end thereof. A frustum herein could have a circular base, a triangular base, a square base, a pentagonal base, a hexagonal base, or any higher order regular polygonal base. As the skilled person knows, the first end of a frustum has a first diameter, and the second (opposing) end of a frustum has a second diameter which is smaller than the first diameter. The first end may therefore be referred to herein as a base of the frustum. In an exemplary embodiment, each frustum may be a circular frustum (i.e. in which the opposing planar surfaces are circular). This may help to achieve high performance at a range of polarisation directions, or even for circularly polarized signals.

The plurality of antenna units may collectively form a perpendicular patch antenna array, or a planar patch antenna array. That is, each antenna unit may comprise at least one pair of dipole antenna elements. Each antenna element may comprise a conductive patch which is oriented parallel with the ground plane (in the case of a planar patch antenna array), or a conductive patch which is oriented perpendicular to the ground plane (in the case of a perpendicular patch antenna array).

The superstructure may be spaced from the antenna unit cells such that the antenna unit cells are located between the ground plane and the superstructure. The antenna unit cells may be spaced from the ground plane by an RF-transmissive foam. The superstructure may be spaced from the antenna unit cells by an RF-transmissive foam. As the skilled person knows, RF-transmissive foam is a foam material which is transmissive to RF electromagnetic signals.

Each frustum may be oriented such that it is smallest in diameter at its closest point to the ground plane. That is say, each frustum may be oriented such that its small diameter end is proximal to the ground plane, and its large diameter end is distal from the ground plane.

Each superstructure unit cell may comprise a plurality of conductive frustums. The plurality of conductive frustums in each unit cell may form a regular array of frustums. For example, the frustums in each unit cell may be arranged such that their nearest neighbour spacing is L, where L is the size of the unit cell. Alternatively, the frustums in each unit cell may be arranged such that their nearest neighbour spacing is 0.5 L. Alternatively, the frustums in each unit cell maybe arranged such that their nearest neighbour spacing is (1/√2) L.

Each frustum may be hollow. Each frustum may be open at each axial end thereof, e.g. so as to resemble a tapered lampshade.

Each frustum may be formed of metal, for example copper or aluminium.

Each superstructure unit cell may comprise a first layer of conductive frustums disposed at a first distance from the ground plane, and a second layer of conductive frustums disposed at a second distance from the ground plane, wherein the second distance is greater than the first distance.

The second layer may comprise fewer frustums than the first layer. The frustums of the first layer may have a nearest neighbour spacing of (1/√2) L, where L is the size of a unit cell, the frustums of the second layer may have a nearest neighbour spacing of 0.5 L, where L is the size of a unit cell.

Each frustum may have a maximum diameter of less than 20 mm, for example less than 15 mm. Each frustum may have a maximum diameter of at least 5 mm, for example at least 10 mm.

Each frustum may have a height (defined herein as the perpendicular separation between the first end and the opposing second end) of less than 10 mm, for example less than 5 mm. Each frustum may have a height of at least 1 mm, for example at least 2 mm.

Each frustum may have a slant angle (that is, an angle between the side surfaces and the base) of between 10 degrees and 80 degrees.

Where each unit cell comprises a plurality of layers of frustums, the first layer may have a first plurality of frustums, and the second layer may have a second plurality of frustums. The first plurality of frustums may be different from the second plurality of frustums. That is, the second plurality of frustums may be a different size from the first plurality of frustums. In one example, the second plurality of frustums may have a smaller diameter and a larger height than the first plurality of frustums.

Each superstructure unit cell may be aligned with a respective antenna unit cell. Therefore, the superstructure unit cells and the antenna unit cells may be arranged in a 1:1 relationship. Each antenna unit cell may be located under a respective superstructure unit cell.

Each antenna unit cell may comprise at least one dipole antenna, for example a first dipole antenna having a first orientation and a second dipole antenna having a second orientation.

The antenna structure may further comprise a drive circuit provided on an opposing side of the ground pane from the antenna unit cells. Each antenna unit cell may be coupled to the drive circuit by at least one conductive line extending from the antenna unit cell to the drive circuit. The drive circuit may comprise a printed circuit board (PCB) drive circuit. The ground plane may be formed on a surface of the PCB, or may be spaced from the PCB.

Each unit cell may be less than 150 mm across, for example less than 100 mm across, such as less than 50 mm across. In an exemplary embodiment, each unit cell may be 45 mm across.

The antenna unit cells may be arranged in a 2-dimensional grid parallel to the ground plane.

### BRIEF DESCRIPTION OF THE FIGURES

Embodiments of the invention will now be described by way of example only with reference to the figures, in which:

FIG. 1 shows a cross-sectional view of a first example antenna structure according to the present disclosure;

FIG. 2 shows a cross-sectional view of a second example antenna structure according to the present disclosure;

FIG. 3 shows a cross-sectional view of the third example antenna structure according to the present disclosure;

FIG. 4 shows a frustum from the first, second, or third example antenna structure according to the present disclosure;

FIG. 5 shows a plan view of a first example frustum layout according to the present disclosure;

FIG. 6 shows a plan view of a second example frustum layout according to the present disclosure;

FIG. 7 shows a plan view of a third example frustum layout according to the present disclosure;

FIG. 8 shows a plan view of a fourth example frustum layout according to the present disclosure; and

FIG. 9 shows the results of a H-plane scan at 45 degrees, with frequency on the X-axis and gain on the Y-axis.

Like reference numerals are used for like components.

### DETAILED DESCRIPTION

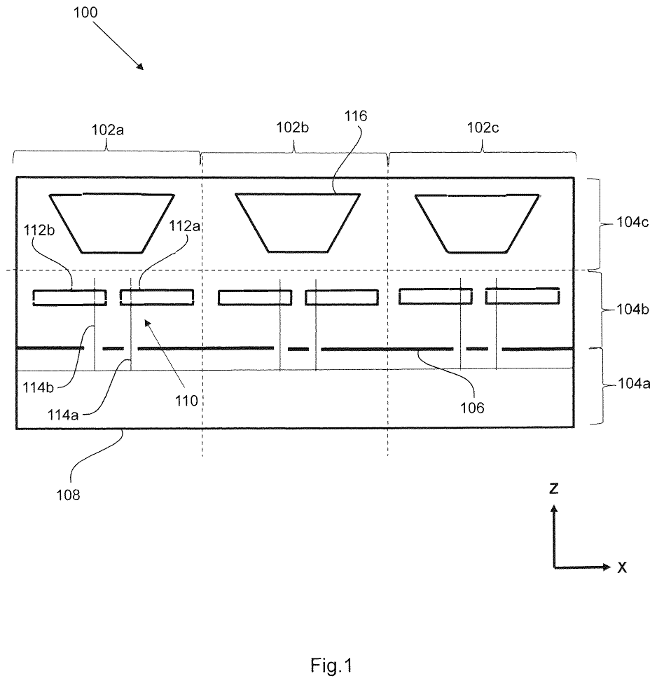

In the present disclosure, we refer to various directions, namely an X direction, a Y direction, and a Z direction. These directions are defined relative to the plane in which the antenna ground plane extends. Namely, the X and Y directions are perpendicular directions which extend parallel to (i.e. in the direction of) the ground plane. The Z direction is defined perpendicular to the X and Y directions (i.e. perpendicular to the ground plane). X and Z axes are accordingly labelled on FIG. 1. The Y axis is perpendicular to the page in FIG. 1.

In the following examples, the WAIM superstructure is illustrated as being incorporated into a planar patch antenna structure (i.e. provided as a superstructure on a planar patch antenna array). However, as the reader will understand, the WAIM superstructure of the present disclosure could be provided as a superstructure for any antenna array, e.g. a perpendicular patch antenna array.

FIG. 1 shows a cross-sectional view of a first example antenna structure 100 according to the present disclosure. As shown, the antenna structure 100 comprises (in the X-Y direction) a plurality of unit cells 102a, 102b, 102c. In the example of FIG. 1, the unit cells are identical to one another. In the Z direction (thickness direction), the antenna structure comprises a substrate layer 104a, an antenna layer 104b, and a superstructure layer 104c. A conductive layer, called a ground plane 106, is provided between the substrate layer 104a and the antenna layer 104b.

The substrate layer 104a comprises a PCB drive circuit 108, which includes drive circuitry for driving antenna elements in the antenna layer 104b. The PCB is separated from the ground plane 106 by an air gap in the example of FIG. 1, but may alternatively be adjacent the ground plane 106.

The ground plane 106 is a conductive layer, for example a layer of aluminium or copper, which is connected to electrical ground. Electrical ground is defined herein relative to the antenna elements and the PCB 108.

Turning now to the antenna layer 104b, we note that three antenna unit cells 102a, 102b, 102c are shown for illustrative purposes, but more or less unit cells than this could be present. Each antenna unit cell is shown as comprising a single antenna dipole pair 110. Each antenna dipole pair 110 comprises a first conductive patch 112a and a second conductive latch 112b. Each conductive patch 112a/112b is connected to the PCB by a corresponding conductive line 114a/114b, such that it can be driven by the PCB. Each conductive patch 112a/112b is oriented parallel with the ground plane 106. In some examples, each antenna unit cell may comprise a first dipole pair 110 extending in the X direction, and a second dipole pair 110 extending in the Y direction. The first and second pairs may intersect each other to form a cross. As the reader will understand, the unit cells 102 may form a two-dimensional array which extend in the x-direction (as shown in FIG. 1), and similarly extend in the y-direction.

The superstructure layer 104c is provided on the antenna layer 104b. The superstructure layer is, similarly to the antenna layer 104b, split into three unit cells 102a, 102b, 102c. The superstructure unit cells align with the antenna unit cells in the Z direction. For each antenna unit cell, there is a corresponding superstructure unit cell.

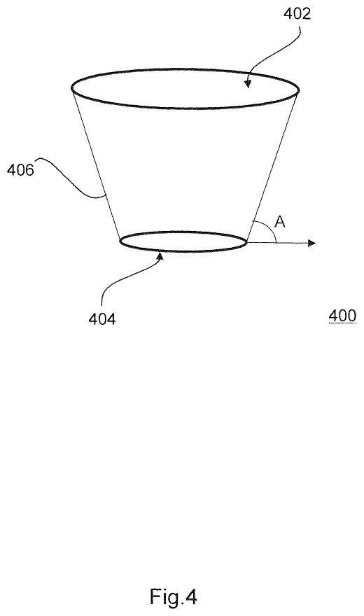

In the example of FIG. 1, each superstructure unit cell comprises a single metallic frustum 116, arranged above a corresponding dipole 110. Each frustum 116 includes a first end and an opposing second end. Each frustum tapers from its first end to its opposing second end, such that it is widest at its first end and narrowest at its second end. Each frustum is oriented such that its first (widest) end is distal from the ground plane 106, and such that its second (narrowest) end is proximal to the ground plane 106. Each frustum 116 is further oriented such that each end thereof is oriented parallel with the ground plane 106. The structure of each frustum is described in further detail in FIG. 4. Each frustum is hollow, and is open at each end. Therefore, each frustum may consist of a tapered conductive side-wall which forms the shape of a frustum.

While the example of FIG. 1 is exemplified with three unit cells in the X-direction, the skilled person will understand that the antenna structure 100 could comprise a 2-dimensional array of unit cells in the X-Y plane. For example, the antenna structure 100 could comprise an N×M array of unit cells, arranged to have N rows of unit cells in the X direction, and M columns of unit cells in the Y direction.

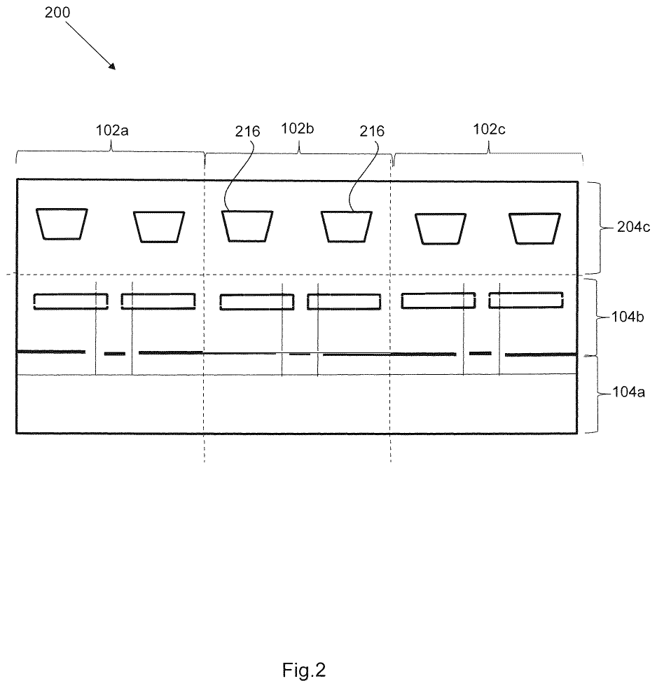

FIG. 2 shows a cross-sectional view of a second example antenna structure 200 according to the present disclosure. The second example antenna structure 200 includes a substrate layer 104a which is identical to the substrate layer 104a from the first example antenna structure 100. The second example antenna structure 200 also includes an antenna layer 104b which is identical to the antenna layer 104b from the first example antenna structure 100. However, the second example antenna structure 200 includes a superstructure layer 204c which is different from the superstructure layer 104c from the first example antenna structure 100. The superstructure layer 204c of the second example antenna structure 200 is described below.

The superstructure layer 204c includes a plurality of unit cells 102a, 102b, 102c, which are located above respective ones of the plurality of antenna unit cells. Each of the superstructure unit cells 102a, 102b, 102c of the superstructure layer 204c includes a plurality of metallic frustums 216. As in the example of FIG. 1, each frustum 216 is oriented such that its first (widest) end is distal from the ground plane 106, and such that its second (narrowest) end is proximal to the ground plane 106. Each frustum 216 is further oriented such that each end thereof is oriented parallel with the ground plane 106. The structure of each frustum 216 is described in further detail in FIG. 4. In the example of FIG. 2, each frustum has a height of between 1 mm-4 mm, and a maximum width of between 8-12 mm. However, as the reader will understand, the exact dimensions will depend on the frequency band(s) of interest.

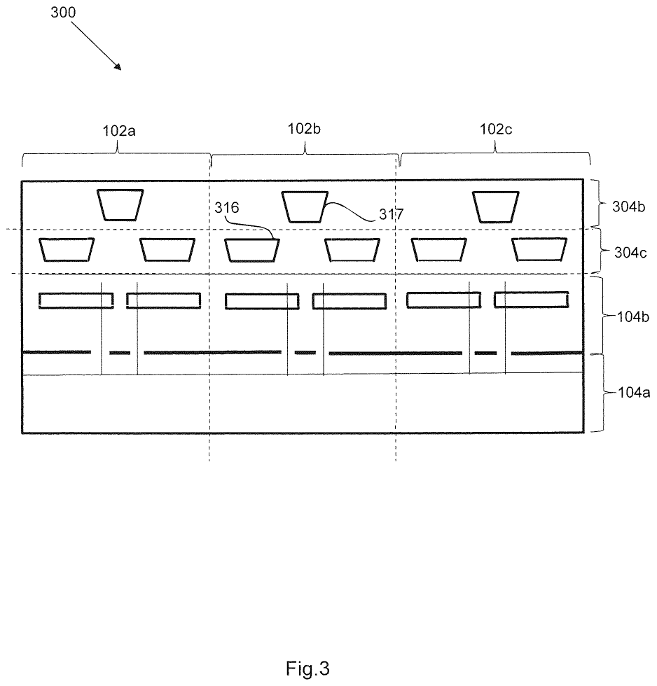

FIG. 3 shows a cross-sectional view of the third example antenna structure 300 according to the present disclosure. The third example antenna structure 300 includes a substrate layer 104a which is identical to the substrate layer 104a from the first example antenna structure 100. The third example antenna structure 300 also includes an antenna layer 104b which is identical to the antenna layer 104b from the first example antenna structure 100. However, the third example antenna structure 300 includes a superstructure layer which is different from the superstructure layer 104c from the first example antenna structure 100. The superstructure layer of the second example antenna structure 200 is described below.

The superstructure layer of the second example antenna structure 200 is split into a first superstructure sub-layer 304c, and a second superstructure sub-layer 304d. The first superstructure sub-layer 304c is located between the second superstructure sub-layer 304d and the antenna layer 104b. In the example structure 300 of FIG. 3, each unit cell in the second sub-layer 304d has fewer frustums than the corresponding unit cell in the first sub-layer 304c.

In the first superstructure sub-layer 304c, a first plurality of frustums 316 are provided. In the second superstructure sub-layer 304d, a second plurality of frustums 317 are provided. Each of the first plurality of frustums 316 has a height of between 1 mm-2 mm, and an outer width of between 10-12 mm. Each of the second plurality of frustums 317 has a height of between 2-4 mm, and an outer width of between 8-10 mm. Therefore, the frustums of the second plurality are narrower than the frustums of the first plurality, and taller than the frustums of the first plurality. However, as the reader will understand, the exact dimensions may depend on the frequency band(s) of interest. In the depicted examples, each unit cell comprises fewer frustums in the second layer 304d than in the first layer 304c.

Without wishing to be bound by theory, it is thought that increasing the number of superstructure sub-layers has the effect of increasing bandwidth. In a further example (not shown) more than two superstructure layers may be present.

In each of the first, second, and third examples, each unit cell 102a, 102b, 102c may be 45 mm across (e.g. 45 mm across in the X direction, and 45 mm across in the Y direction). The antenna layer 104b may be 40 mm thick in the Z direction. The superstructure layer 104c, 204c, or 304c+304d, may be 40 mm thick in the Z direction. As the skilled person will understand, these dimensions will depend on the intended frequency range of operation.

FIG. 4 shows a single frustum 400 as would be used in any of the first, second, or third examples of the present disclosure. The frustum is formed of copper, or aluminium. Typically, the frustum is hollow, is open at its first end 402, and is open at its second end 404. The tapered side-wall 406 is formed of copper or aluminium. The frustum is typically machined from a billet of aluminium or copper. The slant angle (A) of the tapered side-wall may be between 10 degrees and 80 degrees, as defined relative to the X-Y plane. For example, the or each frustum may comprise a tapered side-wall which forms an oblique angle, for example an angle of between 10 degrees and 80 degrees, with respect to the ground plane 106. FIG. 4 exemplifies a circular frustum. In some examples, however, a polygonal frustum may be used, for example a triangular frustum, a square frustum, a pentagonal frustum, a hexagonal frustum, etc.

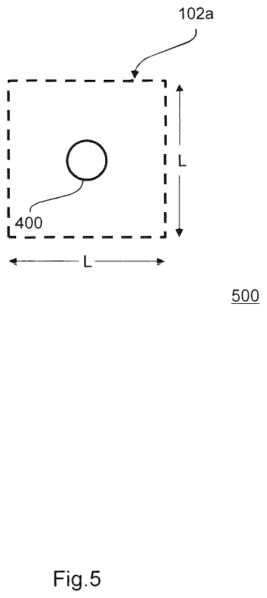

FIG. 5 shows a plan view of a first example frustum layout 500 according to the present disclosure. The plan view is viewed parallel to the Z axis. That is to say, the Z axis is perpendicular to the page in FIG. 5. In FIG. 5, a single unit cell 102a is shown for illustrative purposes. As shown, the unit cell 102a of FIG. 5 includes a single frustum 400 arranged at a centre of the unit cell 102a. This corresponds to the arrangement shown in FIG. 1. The spacing between nearest neighbours of frustums would accordingly be L, where L is the size of the unit cell 102a. In each of FIGS. 5 to 8, L may be 45 mm.

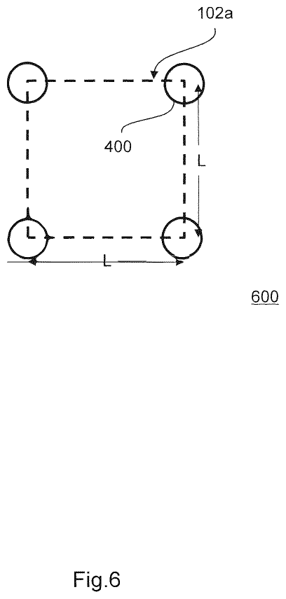

FIG. 6 shows a plan view of a second example frustum layout 600 according to the present disclosure. The plan view is viewed parallel to the Z axis. That is to say, the Z axis is into the page in FIG. 6. In FIG. 6, a single unit cell 102a is shown for illustrative purposes. As shown, the unit cell 102a of FIG. 6 includes four frustums-one at each corner thereof. Each frustum may therefore define an apex between four adjacent unit cells. As with the example of FIG. 5, the spacing to nearest neighbours of frustums is accordingly L, where L is the size of the unit cell 102a.

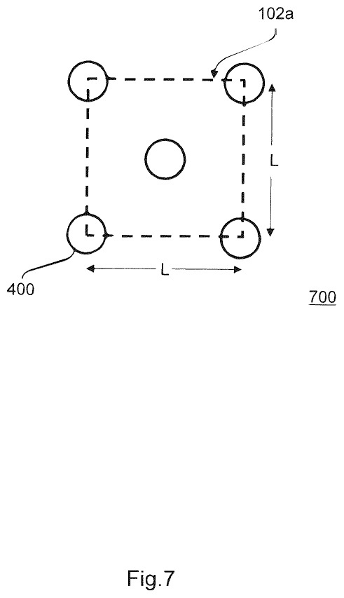

FIG. 7 shows a plan view of a third example frustum layout 700 according to the present disclosure. The plan view is viewed parallel to the Z axis. That is to say, the Z axis is into the page in FIG. 7. In FIG. 7, a single unit cell 102a is shown for illustrative purposes. In FIG. 7, the spacing between nearest neighbours of frustums is (1/√2) L.

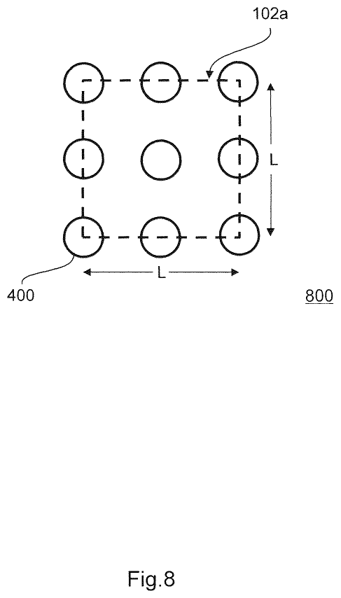

FIG. 8 shows a plan view of a fourth example frustum layout 800 according to the present disclosure. The plan view is viewed parallel to the Z axis. That is to say, the Z axis is into the page in FIG. 8. In FIG. 8, a single unit cell 102a is shown for illustrative purposes. In FIG. 8, the spacing between nearest neighbours of frustums is 0.5 L.

In each of FIGS. 5 to 8, L may be 45 mm. In the example of FIG. 1, the layout according to FIG. 5 is used. In the example of FIG. 2, a layout according to any of FIGS. 6 to 8 can be used. In the example of FIG. 3, the first sub-layer 304c can use a layout according to any of FIGS. 6 to 8, and the second sub-layer 304d can use a layout according to any of FIGS. 6 to 8.

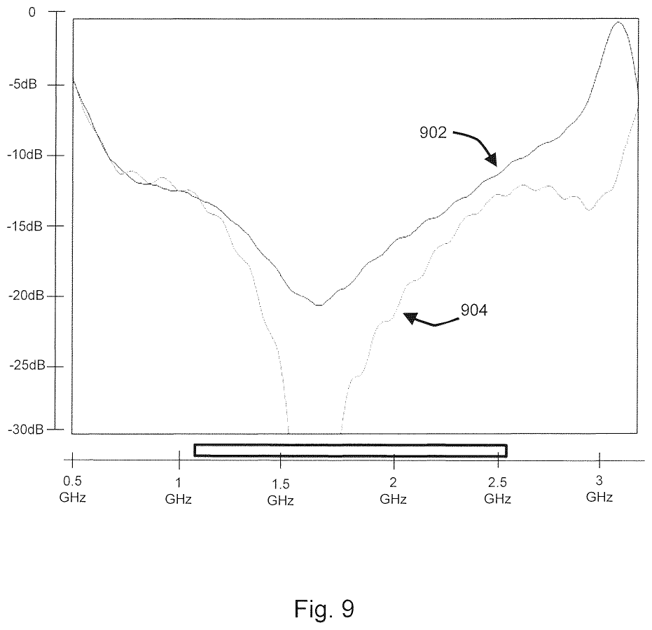

FIG. 9 shows the results of a H-plane scan at 45 degrees, with frequency on the X-axis and gain on the Y-axis. The plot for a planar WAIM belonging to the prior art is labelled as 902. The plot for a WAIM according to FIG. 3 of the present disclosure is labelled as 904. As can be seen, for an antenna manufacturer looking to operate at a target antenna gain of −10 dB, the maximum operating frequency of the antenna is increased from about 2.5 GHz to aver 3 GHz.

The above detailed description is intended to be illustrative, and not restrictive. Many other implementations will be apparent to those skilled in the art upon reading and understanding the above detailed description. Although the present disclosure has been described with reference to limited specific example implementations, it will be recognised that the disclosure is not limited to the implementations described, but can be practiced with modification and alteration insofar as such modification(s) and alteration(s) remain within the scope of the appended claims. The scope of the disclosure should, therefore, be determined with reference to the appended claims, along with the full scope of equivalents to which such claims are entitled.

1. An antenna structure comprising:
a ground plane;
a plurality of antenna unit cells spaced from the ground plane; and
a superstructure spaced from the antenna unit cells, wherein the superstructure comprises a plurality of superstructure unit cells, and wherein each superstructure unit cell comprises at least one conductive frustum, wherein the at least one conductive frustum is arranged such that a base thereof is oriented parallel to the ground plane.

2. The antenna structure of claim 1, wherein each conductive frustum is oriented such that it is smallest in diameter at its closest point to the ground plane.

3. The antenna structure of claim 1, wherein each superstructure unit cell comprises a plurality of conductive frustums.

4. The antenna structure of claim 1, wherein each conductive frustum is hollow.

5. The antenna structure of claim 1, wherein each conductive frustum is open at each axial end thereof.

6. The antenna structure of claim 1, wherein each conductive frustum is formed of metal.

7. The antenna structure of claim 1, wherein each superstructure unit cell comprises a first layer of conductive frustums disposed at a first distance from the ground plane, and a second layer of conductive frustums disposed at a second distance from the ground plane, wherein the second distance is greater than the first distance.

8. The antenna structure of claim 7, wherein the second layer comprises fewer conductive frustums than the first layer.

9. The antenna structure of claim 8, wherein the conductive frustums of the first layer have a nearest neighbour spacing of (1/√2) L, where L is the size of a unit cell.

10. The antenna structure of claim 8, wherein the conductive frustums of the second layer have a nearest neighbour spacing of 0.5 L, where L is the size of a unit cell.

11. The antenna structure of claim 1, wherein each conductive frustum is a circular frustum.

12. The antenna structure of claim 1, wherein each conductive frustum has a maximum diameter is between 5 mm and 20 mm.

13. (canceled)

14. The antenna structure of claim 1, wherein each conductive frustum has a height between 1 mm and 10 mm.

15. (canceled)

16. The antenna structure of claim 1, wherein each conductive frustum has a slant angle of between 10 degrees and 80 degrees.

17. The antenna structure of claim 1, wherein each superstructure unit cell is aligned with a respective antenna unit cell.

18. The antenna structure of claim 1, wherein each antenna unit cell comprises at least one dipole antenna.

19. The antenna structure of claim 1, further comprising a drive circuit provided on an opposing side of the ground plane from the antenna unit cells, and wherein each antenna unit cell is coupled to the drive circuit by at least one conductive line extending from the antenna unit cell to the drive circuit.

20. The antenna structure of claim 1, wherein each antenna unit cell is less than 150 mm across.

21. The antenna structure of claim 1, wherein the antenna unit cells are arranged in a 2-dimensional grid parallel to the ground plane.

22. The antenna structure of claim 20, wherein each antenna unit cell is less than 100 mm across.
